(19) United States
(12) Patent Application Publication
(10) Pub. No.: US 2011/0254987 A1
(43) Pub. Date: Oct. 20, 2011

(54) CMOS IMAGE SENSOR ARRAY WITH INTEGRATED NON-VOLATILE MEMORY PIXELS

(75) Inventor: Dominic Massetti, San Jose, CA (US)

(73) Assignee: OMNIVISION TECHNOLOGIES, INC., Santa Clara, CA (US)

(21) Appl. No.: 13/060,419

(22) PCT Filed: Nov. 18, 2008
(86) PCT No.: PCT/US08/83924

§ 371 Date: Feb. 23, 2011

(51) Int. Cl. H04N 5/335

(52) U.S. Cl. 348/308; 348/E05.091

(57) ABSTRACT

An imaging system includes an imaging array and readout circuitry. The imaging array includes image sensor pixels for capturing image data and one or more non-volatile memory (NVM) pixels for storing NVM data. The readout circuitry is coupled to the imaging array to readout the image data and the non-volatile memory data.

### TECHNICAL FIELD

This disclosure relates generally to image sensors, and in particular but not exclusively, relates to CMOS image sensors having integrated non-volatile memory pixels.

### BACKGROUND INFORMATION

Image sensors have become ubiquitous. They are widely used in digital still cameras, cellular phones, security cameras, as well as, medical, automobile, and other applications. The technology used to manufacture image sensors, and in particular, complementary metal-oxide-semiconductor (“CMOS”) image sensors (“CIS”), has continued to advance at great pace. For example, the demands of higher resolution and lower power consumption have encouraged the further miniaturization and integration of these image sensors.

FIG. 1 is a circuit diagram illustrating pixel circuitry of a four-transistor (“4T”) image sensor pixel 100 within an image sensor array. The image sensor pixel is arranged in a row and a column and time shares a single readout column line (bit line) with pixels on other rows (not shown). Each image sensor pixel 100 includes a photodiode 105, a transfer transistor T1, a reset transistor T2, a source-follower (“SF”) or amplifier (“AMP”) transistor T3, and a row select (“RS”) transistor T4.

During operation, transfer transistor T1 receives a transfer signal TX, which transfers the charge accumulated in photodiode 105 to a floating diffusion node FD. Reset transistor T2 is coupled between a power rail VDD and the floating diffusion node FD to reset the pixel (e.g., discharge or charge the FD and the photodiode 105 to a preset voltage) under control of a reset signal RST. The floating diffusion node FD is coupled to control the gate of AMP transistor T3. AMP transistor T3 is coupled between the power rail VDD and RS transistor T4. AMP transistor T3 operates as a source-follower providing a high impedance connection to the floating diffusion FD. Finally, RS transistor T4 selectively couples the output of the pixel circuitry to the readout column line under control of a signal RS.

### BRIEF DESCRIPTION OF THE DRAWINGS

Non-limiting and non-exhaustive embodiments of the invention are described with reference to the following figures, wherein like reference numerals refer to like parts throughout the various views unless otherwise specified.

FIG. 1 is a circuit diagram illustrating a conventional image sensor pixel.

FIG. 2A is a functional block diagram illustrating an imaging system, in accordance with an embodiment of the invention.

FIG. 2B is a functional block diagram illustrating an imaging system layout, in accordance with an embodiment of the invention.

FIG. 3 is a circuit diagram illustrating a non-volatile memory pixel, in accordance with an embodiment of the invention.

FIG. 4 is a circuit diagram illustrating a non-volatile memory unit including a programming switch and a fuse, in accordance with an embodiment of the invention.

FIG. 5 is a circuit layout illustrating a non-volatile memory pixel, in accordance with an embodiment of the invention.

FIG. 6 is a flow chart illustrating operation of an imaging system including non-volatile memory pixels and imaging pixels, in accordance with an embodiment of the invention.

FIG. 7 is a block diagram illustrating a demonstrative electronic device including an imaging system, in accordance with an embodiment of the invention.

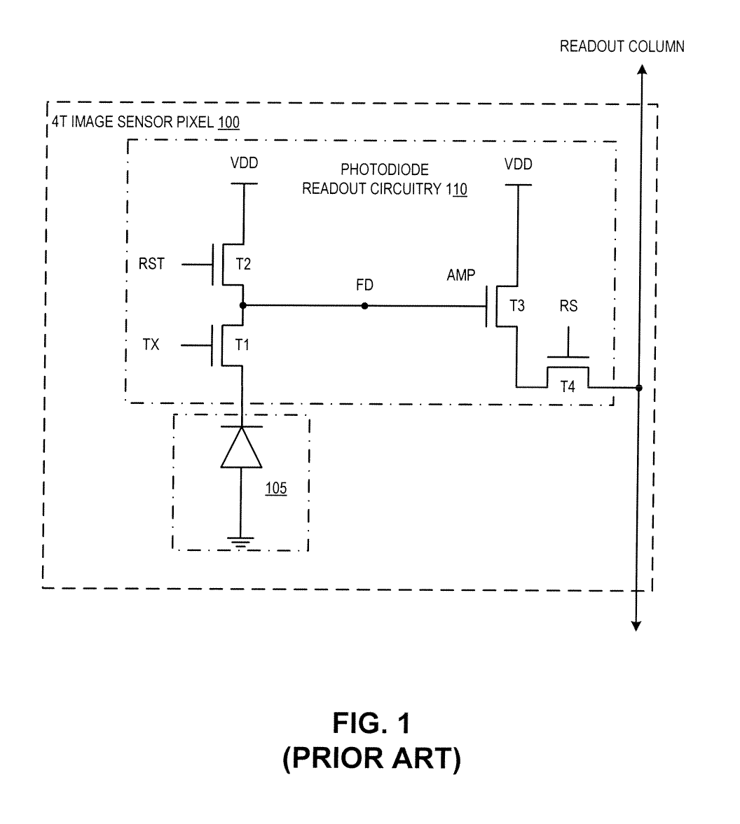

### DETAILED DESCRIPTION

Embodiments of a system and method of operation of a CMOS imaging system with integrated non-volatile memory are described herein. In the following description numerous specific details are set forth to provide a thorough understanding of the embodiments. One skilled in the relevant art will recognize, however, that the techniques described herein can be practiced without one or more of the specific details, or with other methods, components, materials, etc. In other instances, well-known structures, materials, or operations are not shown or described in detail to avoid obscuring certain aspects.

Reference throughout this specification to “one embodiment” or “an embodiment” means that a particular feature, structure, or characteristic described in connection with the embodiment is included in at least one embodiment of the present invention. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

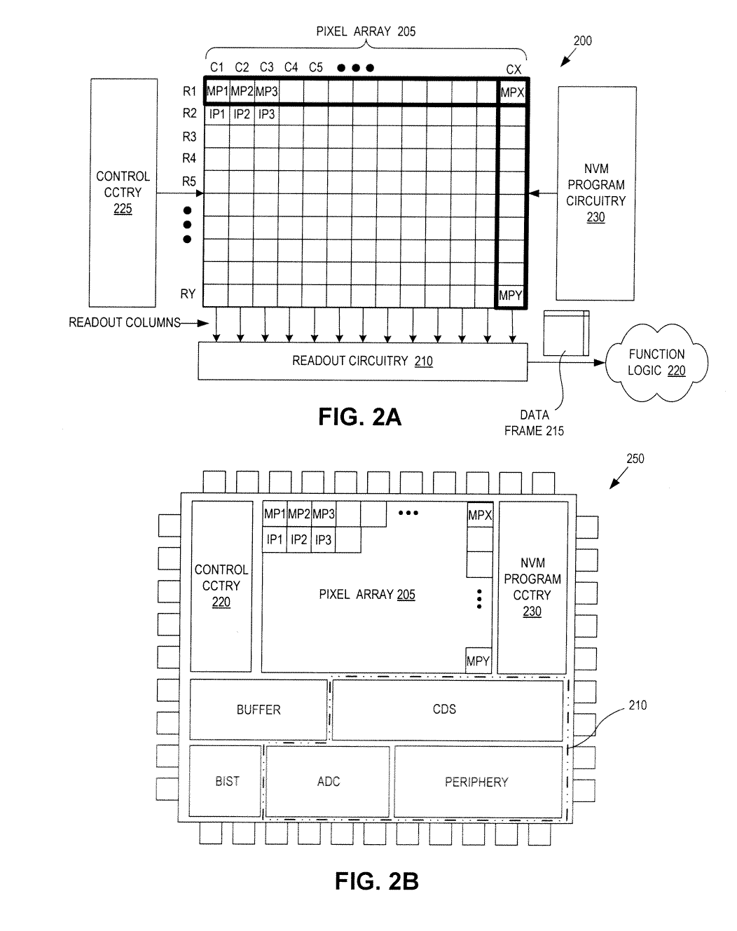

FIG. 2A is a block diagram illustrating an imaging system 200, in accordance with an embodiment of the invention. The illustrated embodiment of imaging system 200 includes a pixel array 205, readout circuitry 210, function logic 220, control circuitry 225, and non-volatile memory (“NVM”) program circuitry 230.

Pixel array 205 is a two-dimensional (“2D”) array of image sensor pixels (e.g., IP1, IP2, IP3 . . . ) and NVM pixels (e.g., MP1, MP2, MP3 . . . MPX as a row and MPX . . . MPY as a column). In one embodiment, each pixel is a complementary metal-oxide-semiconductor (“CMOS”) pixel though other types of pixels may also be used (e.g., charge-coupled devices). As illustrated, each pixel is arranged into a row (e.g., rows R1 to RY) and a column (e.g., column C1 to CX) to provide data. The image sensor pixels provide image data of a captured image and the NVM pixels provide pre-programmed NVM data. The two types of pixels can be read out indistinguishably, so the same sets of encoder and decoder logic may be used to select and readout both the image data and the NVM data from pixel array 205.

While the image sensor pixels acquire the image data of a captured image, the NVM pixels can be used to store NVM data for a variety of purposes, including customizing imaging system 200. For example, the NVM data may represent locations of or coordinates to defective pixels for post-processing correction, may represent a serial number for uniquely identifying pixel array 205, may represent coefficients of a post-processing function applied to the image data, may represent an identification number of an original equipment manufacturer (“OEM”) of an electronic device incorporating imaging system 200, may represent coefficients used in lens selection, or otherwise. The NVM data may also be used as metadata related to the captured image, the capturing device, operation of pixel array 205 itself, or the like. In one embodiment, NVM data includes coefficients that may be used in an algorithm to compensate for shading or color imbalances across pixel array 205. The above list is not intended to be an exhaustive list, but merely a sampling of potential uses for the NVM data stored in the NVM pixels. Furthermore, although the illustrated NVM pixels are disposed within pixel array 205, the NVM pixels could also constitute a standalone array integrated onto the same semiconductor die as the image sensor pixels.

Readout circuitry 210 is shared by both the image sensor pixels and the NVM pixels. In the illustrated embodiment, readout circuitry 210 may readout a row of pixel array 205 at a time along readout column lines. A row may include image sensor pixels, NVM pixels, or both. In one embodiment, readout circuitry 210 may readout the pixel array 205 using a variety of other techniques (not illustrated), such as a column readout, a serial readout, a full parallel readout of all pixels simultaneously, or otherwise.

By incorporating the NVM pixels into pixel array 205, memory is added to imaging system 200 without allocating separate silicon real estate to a dedicated memory element array. In one embodiment, readout circuitry 210 includes amplification circuitry, analog-to-digital (“ADC”) conversion circuitry, holding capacitors, or otherwise.

Decoder logic within control circuitry 225 is also shared by both of the NVM pixels and the image sensor pixels. Control circuitry 225 is coupled to pixel array 205 to control operational characteristics of pixel array 205. As an example, control circuitry 225 may control the timing of row and column selection for the image data and the NVM data readout. Similar to readout circuitry 210, control circuitry 225 may also operate normally without distinguishing between the image sensor pixels and the NVM pixels. The ability to use control circuitry 225 to address both a memory bank (the NVM pixels) and the image sensor pixels also conserves valuable silicon real estate for other purposes.

During operation, function logic 220 receives a data frame 215 from readout circuitry 210. Data frame 215 may includes the image data and the NVM data from pixel array 205. Data frame 215 is transferred to function logic 220 where it may be manipulated or modified. For example, function logic 220 may perform various functions such as store data frame 215, parse all or part of the image data or the NVM data from data frame 215, manipulate all or part of data frame 215 by applying post image effects (e.g., crop, rotate, remove red eye, adjust brightness, or adjust contrast), or otherwise.

FIG. 2B is a block diagram illustrating an imaging system layout 250, in accordance with an embodiment of the invention. The illustrated embodiment of imaging system layout 250 includes pixel array 205, readout circuitry 210, and control circuitry 220, as well as other circuitry such as buffers and built in self test (“BIST”) circuitry. In this embodiment, the NVM pixels (e.g. row: MP1-MPX and column: MPX-MPY) are laid out along the periphery of pixel array 205. Placing NVM pixels along the periphery of pixel array 205 provides accessibility for routing additional signals (e.g. programming lines, pixel selection lines, etc.) to the NVM pixels. In one embodiment, the NVM pixels are disposed along the two sides of pixel array 205 that are the least obstructed by other circuitry (e.g., upper and right sides of pixel array 205 of imaging system layout 250). One skilled in the art having the benefit of the instant disclosure, will recognize that the peripheral locations occupied by the NVM pixels may include one or more sides of pixel array 205 and may consume one or more rows or columns of any side of pixel array 205.

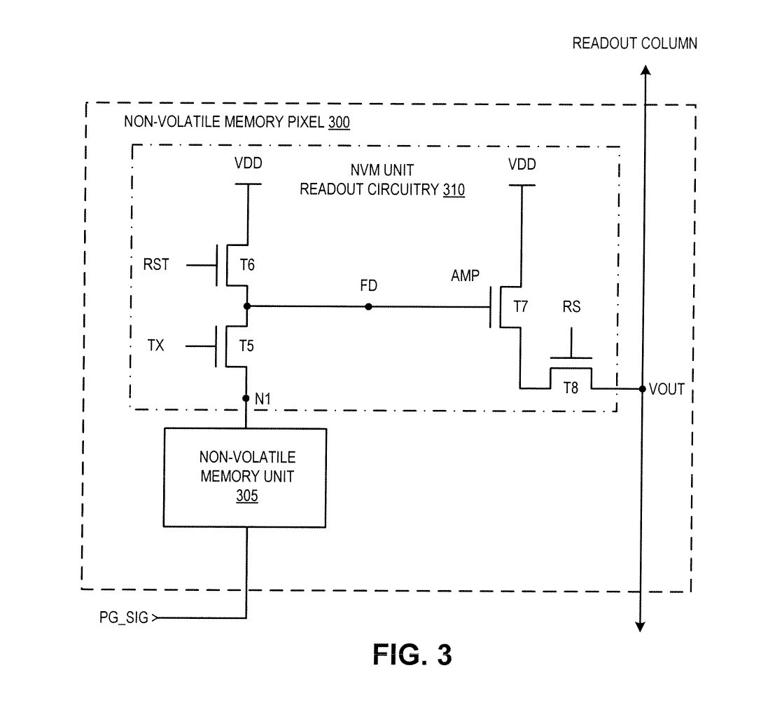

FIG. 3 is a circuit diagram illustrating an NVM pixel 300, in accordance with an embodiment of the invention. NVM pixel 300 represents one possible embodiment of pixel circuitry for implementing NVM pixels such as those illustrated in FIG. 2A. NVM pixel 300 includes an NVM unit 305, a transfer transistor T5, a reset transistor T6, a source-follower (“SF”) or amplifier (“AMP”) transistor T7, and a row select (“RS”) transistor T8. The transistors T5-T8 and floating diffusion node FD form, in part, NVM readout circuitry 310. Although FIG. 3 illustrates a 4T pixel architecture, it should be appreciated that embodiments of the invention are equally applicable to 3T, 5T, and various other pixel architectures.

In one embodiment, NVM pixel 300 is similar to the image pixels of pixel array 205 except that their photodiode is replaced with NVM unit 305. For example, NVM unit 305 may be disposed within NVM pixel 300 in a location corresponding to the photosensitive region of image sensor pixel 100. In the illustrated embodiment, NVM unit 305 is coupled to transfer transistor T5 at a node N1.

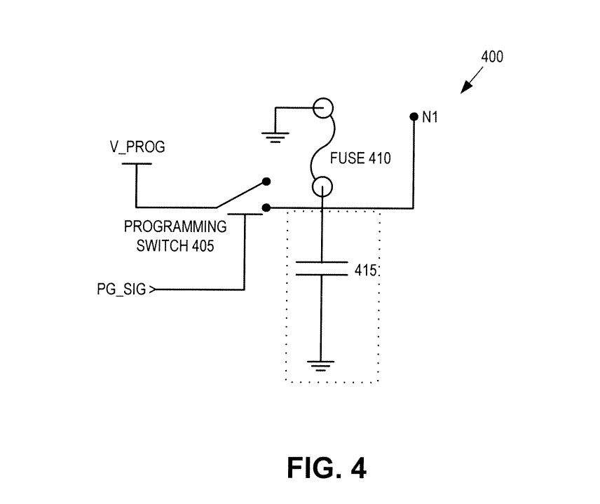

FIG. 4 is a circuit diagram illustrating a non-volatile memory unit 400, in accordance with an embodiment of the invention. NVM unit 400 represents one possible embodiment of NVM unit 305. NVM unit 400 includes a programming switch 405, a fuse 410, and, optionally, a capacitive element 415. NVM unit 400 is coupled to transfer transistor T5 of NVM unit readout circuitry 310 at node N1.

The two programmed states for NVM unit 400 are fuse blown and fuse intact. The fuse blown state is accomplished when programming signal PG_SIG enables programming switch 405. While enabled, programming switch 405 couples programming voltage V_PROG to fuse 410 with a low impedance connection. As a result, fuse 410 is blown or otherwise disrupted. The fuse intact state is accomplished by keeping programming switch 405 open circuited and fuse 410 intact. In one embodiment, programming switch 405 may be implemented as a transistor. In one embodiment, fuse 410 is metal, is only as wide as the minimum width of the fabrication process, and is shaped to be blown efficiently. Alternatively, fuse 410 may be connected to V_PROG while programming switch 405 is connected to ground to blow fuse 410.

Under normal operating conditions, the NVM pixel reads NVM data through node N1, and programming switch 405 isolates V_PROG from fuse 410. The NVM data read through node N1 is determined by the programmed state of fuse 410. When fuse 410 is intact and providing a low impedance connection to ground, node N1 discharges floating diffusion node FD of FIG. 3. A discharged floating diffusion node FD corresponds to a low voltage transferred to the readout column. Readout circuitry 210 or function logic 220 translates the low voltage on the readout column into a high intensity pixel value. A high intensity pixel value from an NVM pixel can then be interpreted as a logic HIGH or digital ‘1’. Alternatively, when fuse 410 is blown, node N1 becomes an open circuit. An open circuit at node N1 does not discharge the node FD; however, NVM unit readout circuitry 310 still performs regular resets of floating diffusion node FD during operation of pixel array 205. Consequently, a reset node FD results in a high voltage transferred to the readout column. The high voltage on the readout column translates to a low intensity pixel value. A low intensity pixel value from an NVM pixel may be interpreted as a logic LOW or digital ‘0’. In one embodiment, capacitive element 415 is disposed between node N1 and ground to add capacitive load to node N1.

The illustrated embodiment of NVM unit 400 may be fabricated using a standard CMOS process. In one embodiment, NVM unit may incorporate other memory designs such as EEPROM, MRAM, FeRAM, or anti-fuse; however, other memory designs may depend on non-standard CMOS processes. Although FIG. 4 illustrates NVM unit 400 as including programming switch 405, in alternative embodiments each NVM unit 400 may not include its own programming switch 405. Rather, these alternative embodiments may share a single programming switch via multiplexing circuitry included within control circuitry 220, the pixel circuitry, or otherwise.

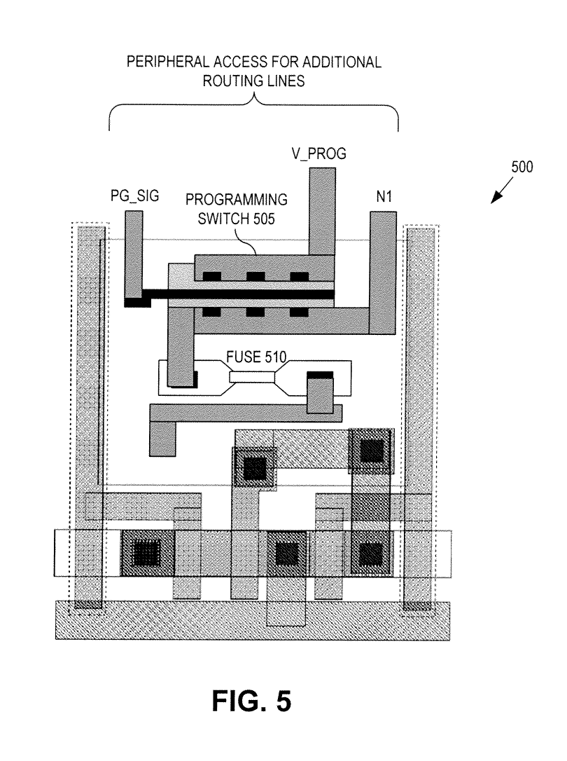

FIG. 5 is a circuit layout illustrating an NVM pixel layout 500, in accordance with an embodiment of the invention. NVM pixel layout 500 is one possible layout implementation of NVM unit 400. The illustrated embodiment of NVM pixel layout 500 includes a programming switch 505, a signal line PG_SIG, a voltage line V_PROG, and a fuse 510. As illustrated, programming switch 505 and fuse 510 are disposed in a location corresponding to a region where photodiode 105 is disposed in image sensor pixel 100. In one embodiment, the optional capacitive element 415 may be disposed as a floating diode below programming switch 505 and fuse 510.

The embodiments of the invention enable NVM pixels to be placed anywhere within the pixel array; however, placing NVM pixels in pixel array 205 somewhere other than along the periphery of the array may require modifications to the fabrication process. For example, a conventional pixel not disposed along the periphery of the pixel array is surrounded by shared circuits or wiring on all sides. Therefore, accessing the additional elements, such as programming switch 505, of an NVM pixel disposed at the center of pixel array 205 may require an additional metal layer in the fabrication process.

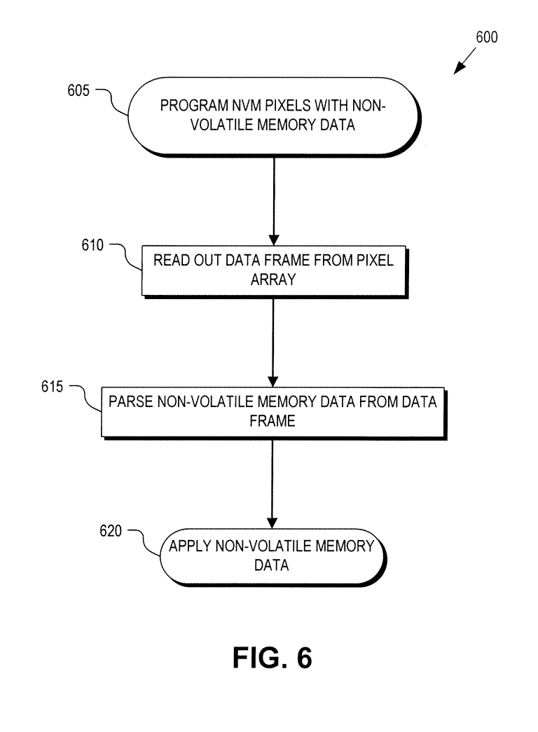

FIG. 6 is a flow chart illustrating operation of imaging system 200, in accordance with an embodiment of the invention. Process 600 is described with reference to circuit diagrams illustrated in FIGS. 2A and 4. The order of some or all of the process blocks appearing in process 600 should not be deemed limiting. Rather one of ordinary skill in the art having the benefit of the present disclosure will understand that some of the process blocks may be executed in a variety of orders not illustrated.

In a process block 605, NVM program circuitry 230 selectively enables the appropriate NVM pixel within pixel array 205 for programming and programs the NVM pixel with NVM data. To facilitate programming, NVM program circuitry 230 may need to be used in concert with control circuitry 225. In one embodiment, programming the NVM pixels includes selectively blowing fuse 410 within each of the NVM pixels via appropriate assertion of programming switch 405.

The ability of on-chip resources, such as NVM program circuitry 230, to program the NVM pixels provides versatility in when the NVM pixels may be programmed. While NVM program circuitry 230 may be used to program the NVM pixels during semiconductor die fabrication or testing, programming may be desirable later in the life-cycle of imaging system 200. As an example, an OEM may desire to program the NVM pixels for customization after placing imaging system 200 in a product, or an end user may want to program information into the NVM pixels for theft protection purposes.

In a process block 610, the image data and the NVM data are read out of pixel array 205. Both image sensor pixels and NVM pixels are addressed by control circuitry 225. By addressing both pixel types from the same control circuitry, silicon real estate does not have to be allocated for dedicated memory addressing circuitry. The data from both pixel types is then readout by readout circuitry 210. Silicon real estate is again conserved by reading out both the image data and the NVM data with the same readout circuitry 210, rather than using readout circuitry dedicated to a memory bank. Readout circuitry 210 may then output the image data and the NVM data as data frame 215.

In a process block 615, function logic 220 receives data frame 215 from readout circuitry 210 and parses the NVM data from data frame 215. Parsing may simply include separating the NVM data from the image data or identifying the NVM data values while allowing the NVM data to remain part of the image file. In one embodiment, function logic 220 is pre-programmed with the locations of the NVM pixels within pixel array 205 and uses the pre-programmed information to perform the parsing function.

In a process block 620, the NVM data may be applied in various functions. NVM data can be used as a serial number identifying imaging system 200, an identification number of an OEM of an electronic device incorporating imaging system 200, coordinates of defective pixels within pixel array 205, or the like. In one embodiment, NVM data includes coefficients that may be used in an algorithm to compensate for shading or color imbalances across pixel array 205. In another embodiment, NVM data may be stored as metadata in an imaging data file and be used to apply adjustments to color filtering. Of course, NVM data may be applied to a variety of uses not explicitly mentioned herein.

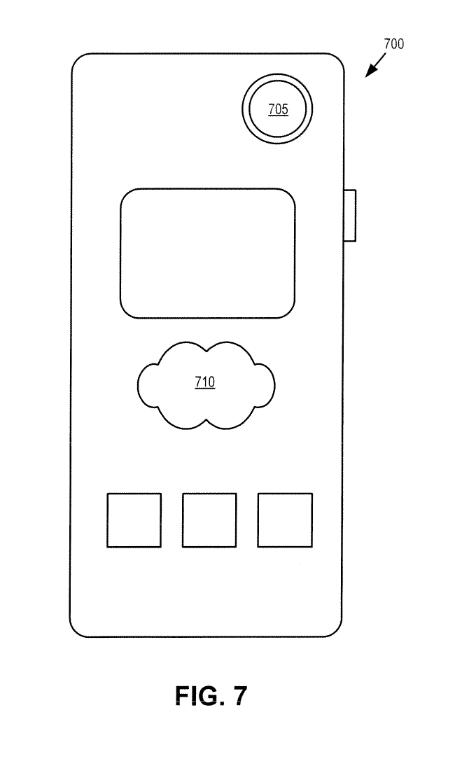

FIG. 7 is a block diagram illustrating a demonstrative electronic device 700 (e.g., wireless communication device) including imaging system 200, in accordance with an embodiment of the invention. In electronic device 700, a complementary metal-oxide-semiconductor (“CMOS”) image sensor (“CIS”) array 705 is housed in a module including a lens used to focus light upon CIS array 705. CIS array 705 captures image data and transfers the image data along with the NVM data to system logic 710. System logic 710 may use the NVM data to store or display an image. The image may or may not also included the NVM data. In one embodiment, system logic 710 uses the NVM data to improve or enhance the quality of the image by applying manufacturer specific filters to the imaging data.

The processes explained above are described in terms of computer software and hardware. The techniques described may constitute machine-executable instructions embodied within a machine (e.g., computer) readable storage medium, that when executed by a machine will cause the machine to perform the operations described. Additionally, the processes may be embodied within hardware, such as an application specific integrated circuit (“ASIC”) or the like.

A machine-readable storage medium includes any mechanism that provides (i.e., stores) information in a form accessible by a machine (e.g., a computer, network device, personal digital assistant, manufacturing tool, any device with a set of one or more processors, etc.). For example, a machine-readable storage medium includes recordable/non-recordable media (e.g., read only memory (ROM), random access memory (RAM), magnetic disk storage media, optical storage media, flash memory devices, etc.).

The above description of illustrated embodiments of the invention, including what is described in the Abstract, is not intended to be exhaustive or to limit the invention to the precise forms disclosed. While specific embodiments of, and examples for, the invention are described herein for illustrative purposes, various modifications are possible within the scope of the invention, as those skilled in the relevant art will recognize.

These modifications can be made to the invention in light of the above detailed description. The terms used in the following claims should not be construed to limit the invention to the specific embodiments disclosed in the specification. Rather, the scope of the invention is to be determined entirely by the following claims, which are to be construed in accordance with established doctrines of claim interpretation.

What is claimed is:

1. An imaging system, comprising:
an imaging array including:
a plurality of image sensor pixels for capturing image data; and
at least one non-volatile memory (“NVM”) pixel for storing NVM data, and
readout circuitry coupled to the imaging array for reading out the image data and the NVM data.

2. The imaging system of claim 1, wherein the imaging array further comprises a plurality of NVM pixels.

3. The imaging system of claim 2, wherein the plurality of NVM pixels forms at least one of a row or a column of the imaging array.

4. The imaging system of claim 3, wherein the plurality of NVM pixels reside along a periphery of the imaging array.

5. The imaging system of claim 2, further comprising NVM program circuitry coupled to selectively program the NVM data into the plurality of NVM pixels.

6. The imaging system of claim 1, wherein:
each of the plurality of image sensor pixels comprises:
a photosensitive element residing in a photosensitive region; and
first pixel circuitry coupled to the photosensitive element for reading out the image data from the photosensitive element; and,
the NVM pixel comprises:
an NVM unit residing in a region corresponding to the photosensitive region of the plurality of image sensor pixels; and
second pixel circuitry coupled to the NVM unit for reading out the NVM data from the NVM unit.

7. The imaging system of claim 6, wherein the first pixel circuitry is identical to the second pixel circuitry.

8. The imaging system of claim 6, wherein the NVM unit comprises a programmable fuse.

9. The imaging system of claim 1, wherein the imaging system is integrated on a single semiconductor die.

10. A method of operating a complementary metal-oxide semiconductor (“CMOS”) image sensor (“CIS”) array having integrated non-volatile memory (“NVM”) pixels and image sensor pixels included within the CIS array, the method comprising:
programming NVM data into the NVM pixels;
acquiring image data with the image sensor pixels; and
reading out a data frame including the NVM data and the image data from the CIS array.

11. The method of claim 10, further comprising parsing the NVM data from the data frame by passing the data frame into system logic.

12. The method of claim 11, further comprising storing the data frame as an image file, wherein the image file includes the NVM data stored as metadata.

13. The method of claim 11, wherein the NVM data includes coefficients used for applying an algorithm to the image data.

14. The method of claim 10, wherein the NVM data includes a serial number for uniquely identifying the CIS array.

15. The method of claim 10, wherein the NVM data includes a coordinate for identifying a defective image sensor pixel in the CIS array.

16. The method of claim 10, wherein programming the NVM data into the NVM pixels is performed after fabrication.

17. The method of claim 10, wherein programming the NVM data into the NVM pixels comprises:
selecting a programming transistor with NVM programming circuitry; and
applying a voltage to a fuse via the programming transistor.

18. A system comprising:
a complementary metal-oxide semiconductor (“CMOS”) image sensor (“CIS”) array including a plurality of non-volatile memory (“NVM”) pixels for storing NVM data and a plurality of image sensor pixels for capturing image data;
readout circuitry coupled to the CIS array for reading out the image data and the NVM data; and
system logic coupled to receive the NVM data and the image data from the readout circuitry, the system logic enabled to distinguish the NVM data from the image data.

19. The system of claim 18, wherein the plurality of NVM pixels store data for improving or modifying the quality of a captured image.

20. The system of claim 18, wherein the system is a wireless communication device.
